(19) United States
(12) Patent Application Publication
(10) Pub. No.: US 2026/0072373 A1
(43) Pub. Date: Mar. 12, 2026

(54) IMAGE FORMING APPARATUS

(71) Applicant: CANON KABUSHIKI KAISHA, Tokyo (JP)

(72) Inventor: YUSUKE MORISHITA, Saitama (JP)

(21) Appl. No.: 19/313,517

(22) Filed: Aug. 28, 2025

(30) Foreign Application Priority Data
Sep. 10, 2024 (JP) 2024-155511

(51) Int. Cl. G03G 15/041; B41J 2/447; B41J 2/47; G03G 15/04; G06K 15/02

(52) U.S. Cl. CPC G03G 15/0415; B41J 2/447; B41J 2/47; G03G 15/04036; G06K 15/1892

(57) ABSTRACT

An image forming apparatus includes a rotational photosensitive member, an exposure device including a plurality of light emitting elements and a driving unit, an output unit configured to superimpose a clock signal on image data, and output the image data as serial data, a generation unit configured to recover and generate the clock signal superimposed on the image data, a conversion unit configured to receive the serial data and convert the received serial data into parallel data, a lock signal output unit configured to lock the generation unit and output a lock signal in a case where the generation unit generates the clock signal at a predetermined frequency, and a control unit configured to count a number of times the conversion unit has not received the serial data normally during a predetermined period, and unlock the generation unit in a case where the number of times exceeds a predetermined value.

### BACKGROUND

### Field of the Technology

The present disclosure relates to an image forming apparatus.

### Description of the Related Art

For electrophotographic printers, there has been generally known a method that forms a latent image by exposing a photosensitive drum using an exposure head employing light emitting elements such as a light-emitting diodes (LEDs) or organic electro-luminescence (EL).

There has been known a configuration that transmits image data via high-speed serial communication according to the recent improvement of the image quality and the productivity of printers. Especially, for serial communication, there has been known an embedded clock-type serial communication technique that transmits image data with a clock signal superimposed on a data signal with the aim of reducing the number of signal lines. US2009/012324 describes a configuration of an image forming apparatus that transfers image data using high-speed serial communication.

In the case of such an image forming apparatus, the clock signal superimposed on the serial communication should be recovered on a receiving side of the serial communication. A recovery circuit should be locked when the clock signal is recovered. However, if the recovery circuit in the locked state is unlocked due to an influence of noise such as static electricity, the clock signal may fail to be recovered properly, making correct transmission of the image data impossible.

### SUMMARY

The present disclosure is directed to reducing a possibility that data cannot be correctly transmitted in an image forming apparatus configured to communicate a data signal by a serial communication method.

According to an aspect of the present disclosure, an image forming apparatus is configured to form an image on a recording medium, and the image forming apparatus includes a rotational photosensitive member, an exposure device including a plurality of light emitting elements and a driving unit, the plurality of light emitting elements being arranged along a rotational axis direction of the photosensitive member and configured to emit light to expose the photosensitive member, the driving unit being configured to drive the plurality of light emitting elements, an output unit configured to superimpose a clock signal for driving the exposure device on image data for controlling lighting-up of the plurality of light emitting elements, and output the image data as serial data, a generation unit configured to recover and generate the clock signal superimposed on the image data, a conversion unit configured to receive the serial data output from the output unit and convert the received serial data into parallel data, a lock signal output unit configured to lock the generation unit and output a lock signal in a case where the generation unit generates the clock signal at a predetermined frequency, and a control unit configured to count a number of times that the conversion unit has not received the serial data normally during a predetermined period, and unlock the generation unit in a case where the number of times that the conversion unit has not received the serial data normally exceeds a predetermined value.

Features of the present disclosure will become apparent from the following description of embodiments with reference to the attached drawings. The following description of embodiments is described by way of example.

### BRIEF DESCRIPTION OF THE DRAWINGS

FIG. 1 illustrates the configuration of an image forming apparatus.

FIGS. 2A and 2B illustrate how a photosensitive drum and an exposure head are arranged.

FIGS. 3A and 3B illustrate the configuration of a printed circuit board.

FIG. 4 is a block diagram of an image controller and the printed circuit board.

FIGS. 5A and 5B illustrate a calculation of an image data corruption monitoring time.

FIGS. 6A, 6B, and 6C illustrate a method for calculating the image data corruption monitoring time.

FIG. 7 is a schematic view of stored data of the image data corruption monitoring time.

FIG. 8 is a flowchart according to a first embodiment.

### DESCRIPTION OF THE EMBODIMENTS

### First Embodiment

### Overall Configuration of Image Forming Apparatus

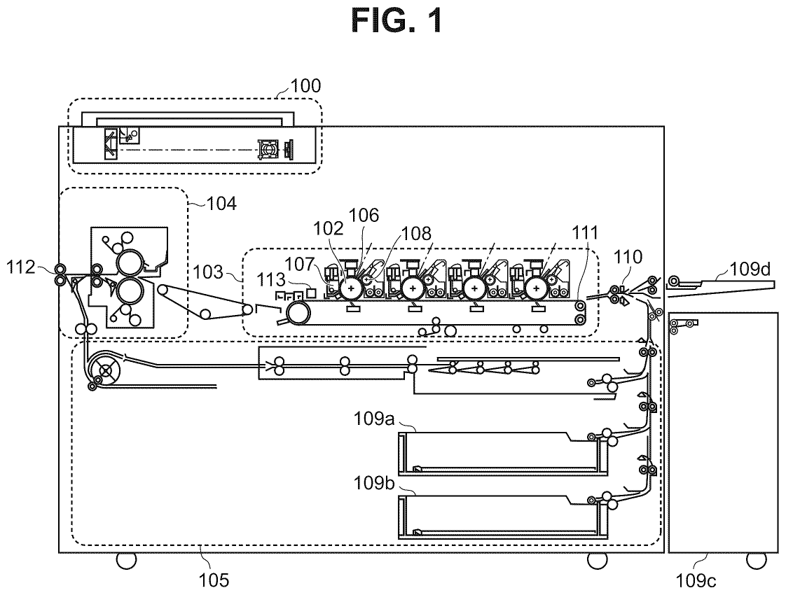

An electrophotographic image forming apparatus according to a first embodiment will be briefly described. FIG. 1 illustrates the overall configuration of the apparatus. The present image forming apparatus includes a scanner unit 100, an image forming unit 103, a fixing unit 104, a sheet feeding and conveyance unit 105, and a printer control unit (not illustrated) that controls these units.

The scanner unit 100 illuminates a document placed on a platen to optically read an image on the document, and converts this image into an electric signal to generate image data. The image forming unit 103 rotationally drives a photosensitive drum 102, and charges the photosensitive drum 102 by a charging device 107.

An exposure head 106 emits light according to the above-described image data and collects the emitted light onto the photosensitive drum 102 with a chip surface including a group of light emitting elements arranged thereon, thereby generating an electrostatic latent image.

A development device 108 develops the electrostatic latent image formed on the photosensitive drum 102 using toner. The developed toner image is transferred onto a recording medium (for example, paper) conveyed on a transfer belt 111.

The image forming unit 103 includes four image forming units, each of which performs the above-described series of electrophotographic processes (charging, exposing, developing, and transferring), and a full-color image is formed by arranging them in the order of cyan (C), magenta (M), yellow (Y), and black (K). The above-described four image forming units sequentially perform magenta, yellow, and black image forming operations after a predetermined time has elapsed since a start of image formation at the cyan station.

The sheet feeding and conveyance unit 105 feeds paper from a pre-specified sheet feeding unit among sheet feeding units 109a and 109b provided inside the main body, an external sheet feeding unit 109c, and a manual sheet feeding unit 109d, and the fed paper is conveyed to a registration roller 110. The registration roller 110 conveys the paper onto the transfer belt 111 at a timing when the toner image formed by the above-described image forming unit 103 is transferred onto the paper. An optical sensor 113 is disposed at a position facing the transfer belt 111, and detects a position of a test chart printed on the transfer belt 111 to calculate a color misalignment amount among the stations. A not-illustrated image controller unit is notified of the calculated color misalignment amount, and the image position of each color is corrected. Due to this control, a full-color toner image free from color misalignment is transferred onto the paper.

The fixing unit 104 is formed of a combination of rollers, and includes a built-in heat source such as a halogen heater. The fixing unit 104 melts and fixes the toner on the paper bearing the toner image transferred from the above-described transfer belt 111 using heat and a pressure, and discharges the paper out of the image forming apparatus by a sheet discharge roller 112.

The printer control unit (not illustrated) communicates with a multifunction peripheral (MFP) control unit that controls the entire MFP, and performs control according to an instruction thereof and also instructs the above-described scanner, image forming, fixing, and sheet feeding and conveyance units so as to allow them to smoothly operate in harmony as a whole while managing their respective states.

### Configuration of Exposure Head

The exposure head 106 configured to expose the photosensitive drum 102 will be described.

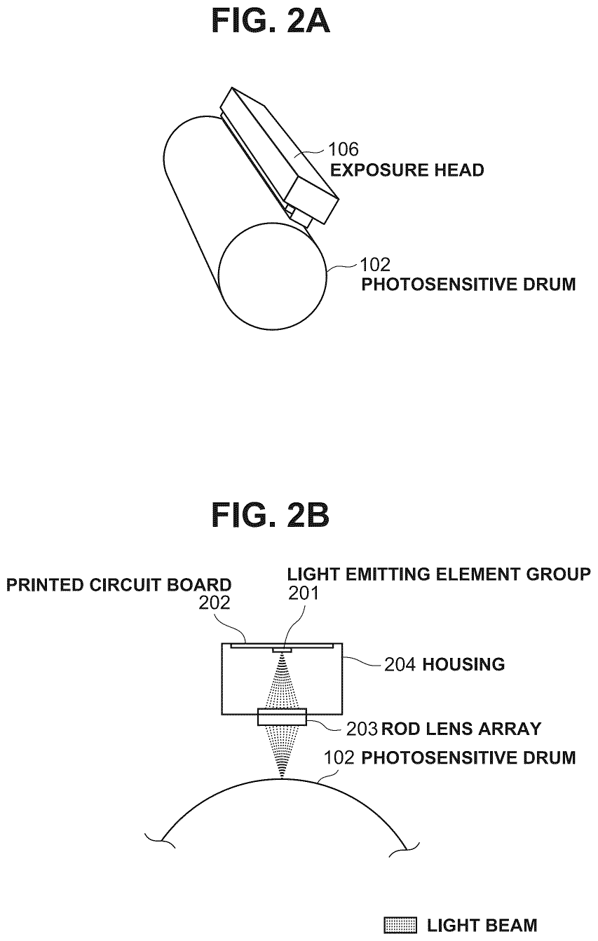

FIGS. 2A and 2B illustrate how the exposure head 106 is arranged relative to the photosensitive drum 102, and how light emitted from a light emitting element group 201 is collected onto the photosensitive drum 102 by a rod lens array 203, respectively. The exposure head 106 and the photosensitive drum 102 are each mounted on the image forming apparatus using a not-illustrated mount member. The exposure head 106 includes the light emitting element group 201 (a plurality of light emitting units) arranged along a rotational axis direction of the photosensitive drum 102, the printed circuit board 202 with the light emitting element group 201 mounted thereon, the rod lens array 203, and a housing 204 to which the rod lens array 203 and the printed circuit board 202 are attached, and is fixed in such a manner that the light emitted from the light emitting element group 201 forms an image on the photosensitive drum 102.

### Configuration of Printed Circuit Board 202

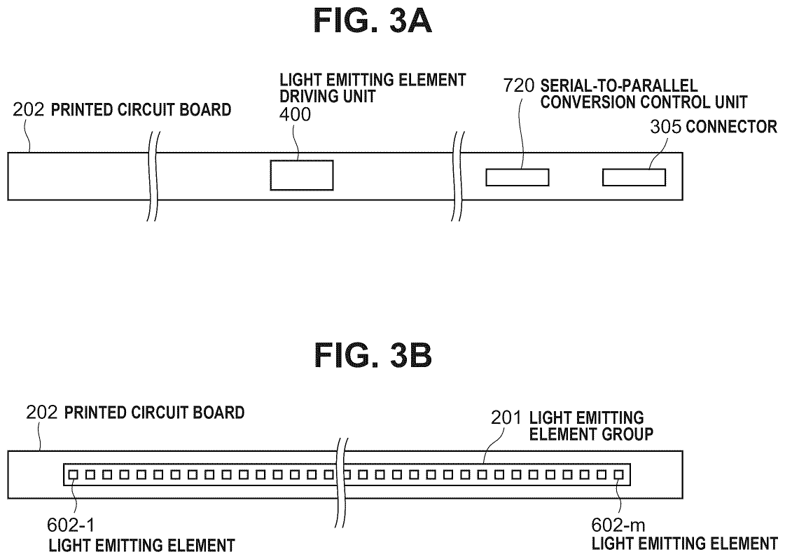

FIGS. 3A and 3B illustrate the printed circuit board 202 with the light emitting element group 201 arranged thereon.

FIG. 3A illustrates a surface opposite from a surface on which the light emitting element group 201 is mounted (hereinafter referred to as a light emitting element non-mounted surface) and FIG. 3B illustrates the surface on which the light emitting element group 201 is mounted (hereinafter referred to as a light emitting element mounted surface). The light emitting element group 201 has such a configuration that a plurality of light emitting elements 602 (602-1 to 602-n) is arranged. Each of the light emitting elements 602 is arranged at a predetermined resolution pitch in the longitudinal direction of the chip. In the present embodiment, the pitch between the light emitting elements 602 adjacent in the chip longitudinal direction is set to a pitch corresponding to a resolution of 1200 dpi (approximately 21.16 μm). The arrangement of as many light emitting elements 602 as n=14173 allows the light emitting element group 201 to form an image corresponding to an image width of approximately 300 mm in the longitudinal direction of the photosensitive drum 102. In the present disclosure, the above-described distance between the light emitting elements 602 and the above-described number thereof shall not have to be limited to the pitch corresponding to the above-described resolution and the above-described number.

A serial-to-parallel conversion control unit 720, a light emitting element driving unit 400, and a connector 305 are disposed on the light emitting element non-mounted surface. Besides light emitting elements based on the inorganic electro-luminescence (EL) method, light emitting elements based on the organic EL method may be used as the light emitting element group 201.

A control signal for controlling the light emitting element driving unit 400 is input from the not-illustrated image controller unit to the serial-to-parallel conversion control unit 720 via the connector 305 as serial data. The serial-to-parallel conversion control unit 720 recovers the input serial data into parallel data, and feeds the recovered parallel data to the light emitting element driving unit 400. A power source line required for the printed circuit board 202 is also supplied to the printed circuit board 202 via the connector 305.

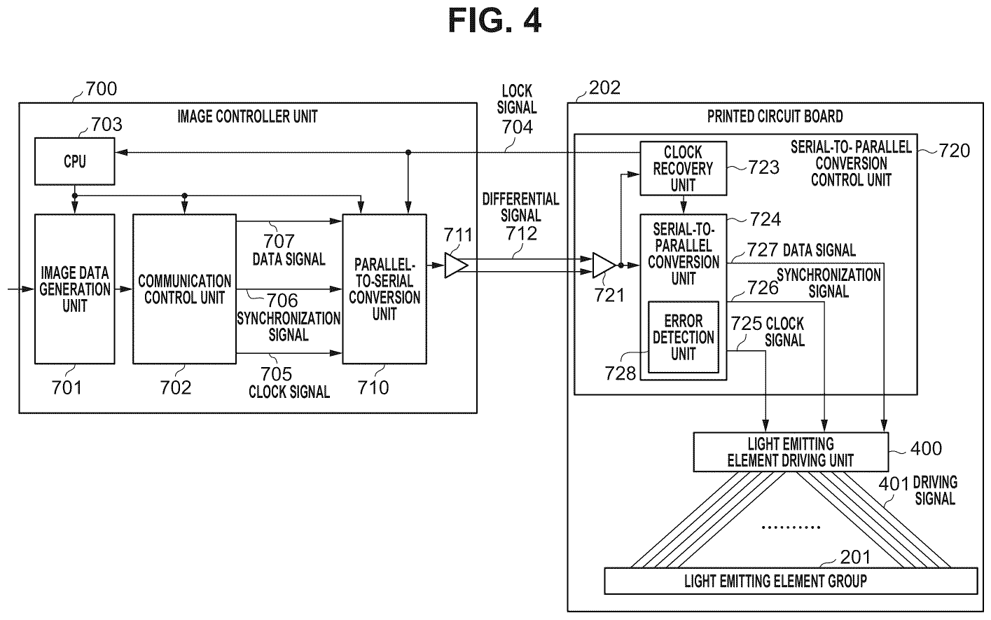

The details of the serial-to-parallel conversion control unit 720 will be described below together with a parallel-to-serial conversion unit on the transmission side with reference to FIG. 4, which will be described below.

### Control Block

FIG. 4 illustrates a block diagram of the image controller unit 700 and the printed circuit board 202. In the present embodiment, data communication between the image controller unit 700 and the printed circuit board 202 is assumed to be carried out via serial communication employing the embedded clock technique.

The present embodiment will be described citing processing for one color for simplification of the description, but it is assumed that similar processing is performed in parallel for the four colors simultaneously.

The image controller unit 700 has a function of generating the signal for controlling the light emitting element driving unit 400 that is directed to the printed circuit board 202 according to an instruction from the printer control unit, and transmitting it.

The image controller unit 700 includes a central processing unit (CPU) 703, an image data generation unit 701, a communication control unit 702, a parallel-to-serial conversion unit 710, and a differential signal driver 711.

The image data generation unit 701 generates the signal for controlling the light emission of the light emitting element driving unit 400 on the printed circuit board 202 according to an instruction from the printer control unit. More specifically, the image data generation unit 701 performs dithering processing on the image data received from the scanner unit 100 or outside the image forming apparatus at a resolution specified by the CPU 703, thereby generating image data for a print output. In the present embodiment, the dithering processing is assumed to be performed at a resolution of 1200 dpi in the chip longitudinal direction (a main scanning direction) in conformity with the pitch of the light emitting elements and at a resolution of 1200 dpi in a sub-scanning direction. Assume that the image data is binary with 1 representing lighting-up.

The communication control unit 702 transmits the image data generated by the image data generation unit 701 as a data signal 707 at a timing that allows the resolution in the sub-scanning direction to match 1200 dpi in relation to the predetermining rotational speed of the photosensitive drum 102 based on information indicating a speed at which the surface of the photosensitive drum 102 moves in the rotational direction. More specifically, the communication control unit 702 generates a clock signal 705, a synchronization signal 706, which indicates a start timing of communication data, and the data signal 707 for setting image data assigned to the light emitting elements or a register of the light emitting element driving unit 400. If being requested to transmit a register setting value to the light emitting element driving unit 400 by the CPU 703, the communication control unit 702 operates so as to transmit the register setting data. At this time, header information is added at the beginning of the data signal 707 so as to make the data type identifiable. The synchronization signal 706 is also transmitted at the same time so as to make the beginning of the data identifiable.

The signal output from the communication control unit 702 is converted into a serial signal by the parallel-to-serial conversion unit 710. More specifically, the clock signal 705, the synchronization signal 706, and the data signal 707 in a plurality of bits are converted into a serial signal and are output. In other words, the parallel-to-serial conversion unit 710 corresponds to an output unit. The serial signal output from the parallel-to-serial conversion unit 710 is converted into a differential signal 712 by the differential signal driver 711, and is output to the printed circuit board 202. The present embodiment indicates an example in which the data is transferred between the image controller unit 700 and the printed circuit board 202 via one pair of differential signals, though, this may be two pairs or may be four pairs according to a required transfer speed.

The printed circuit board 202 is configured as described above referring to FIGS. 3A and 3B, and includes a serial-to-parallel conversion control unit 720, the light emitting element driving unit 400, the light emitting element group 201, and the connector 305. The serial-to-parallel conversion control unit 720 further includes a differential signal receiver 721, a clock recovery unit 723, and a serial-to-parallel conversion unit 724. Further, the serial-to-parallel conversion unit 724 includes an error detection unit 728, and the error detection unit 728 monitors image data corruption of communication data. The details of a method for monitoring image data corruption will be described below.

The differential signal 712 output from the differential signal driver 711 of the image controller unit 700 is input to the printed circuit board 202 via a transmission path on the board, a cable, and the connector 305, and is received by the differential signal receiver 721 and converted into a normal single-ended signal. The signal converted into the single-ended signal is input to the clock recovery unit 723, and the clock superimposed on the serial signal is recovered by the clock recovery unit 723. The signal converted into the single-ended signal by the differential signal receiver 721 is also input to the serial-to-parallel conversion unit 724, and the data is sampled based on the clock recovered by the clock recovery unit 723, converted into a parallel signal, and then output.

The parallel signal output from the serial-to-parallel conversion unit 724 is the same as the signal output from the communication control unit 702 before being serialized. More specifically, a clock signal 725, a synchronization signal 726, and a data signal 727 are output to the light emitting element driving unit 400.

A predetermined time is taken for the signal to pass through the parallel-to-serial conversion unit 710 and the serial-to-parallel conversion unit 724. This time (delay) varies depending on how the units are mounted and the transmission path between the chips, but this delay is generally constant regardless of transferred data in one system where the units are mounted in a fixed manner and the transmission path is fixed.

A driving signal 401 is connected from the light emitting element driving unit 400 to each light emitting element 602 in the light emitting element group 201, and the light emission is controlled in this way.

The clock recovery unit 723 outputs a lock signal 704. This lock signal 704 is a signal that means completion of adjustments of a phase and a predetermined frequency for recovering the clock signal 725 superimposed on the serial signal input to the clock recovery unit 723. This lock signal 704 is input to the parallel-to-serial conversion unit 710 and the CPU 703.

The operation of the lock signal 704 will be described. Immediately after the image forming apparatus is powered on, the clock recovery unit 723 is in an unlocked state, and therefore the parallel-to-serial conversion unit 710 transmits a communication training signal for locking the clock recovery unit 723 to the clock recovery unit 723. After the regeneration of the clock is completed by the clock recovery unit 723, the clock recovery unit 723 notifies the parallel-to-serial conversion unit 710 and the CPU 703 that the image data can be transferred by setting the lock signal 704 to a Low level. If the clock recovery unit 723 is unlocked due to noise after being first locked by the initial communication training, the clock recovery unit 723 sets the lock signal 704 to a High level. As a result, the clock recovery unit 723 notifies the parallel-to-serial conversion unit 710 that the regenerated clock is not stable. Upon being notified, the parallel-to-serial conversion unit 710 transmits the communication training signal again and performs the communication training operation for locking the clock recovery unit 723. Accordingly, the clock recovery unit 723 corresponds to a lock signal output unit. Because this communication training operation is performed without the intervention of the CPU 703, the communication is re-established by transmitting the training signal again as described above even when the clock recovery unit 723 is unlocked while image data is transferred via the serial communication unit. This allows the image transfer to continue, but appropriate processing according to the configuration of the apparatus, such as stopping the operation of the main body by the CPU 703, is performed if abnormality accidentally occurs to an image on a print output due to absence of the intended light emission control until the clock recovery unit 723 is locked again since being unlocked during the control of the light emitting elements as described above.

### Method for Monitoring Image Data Corruption

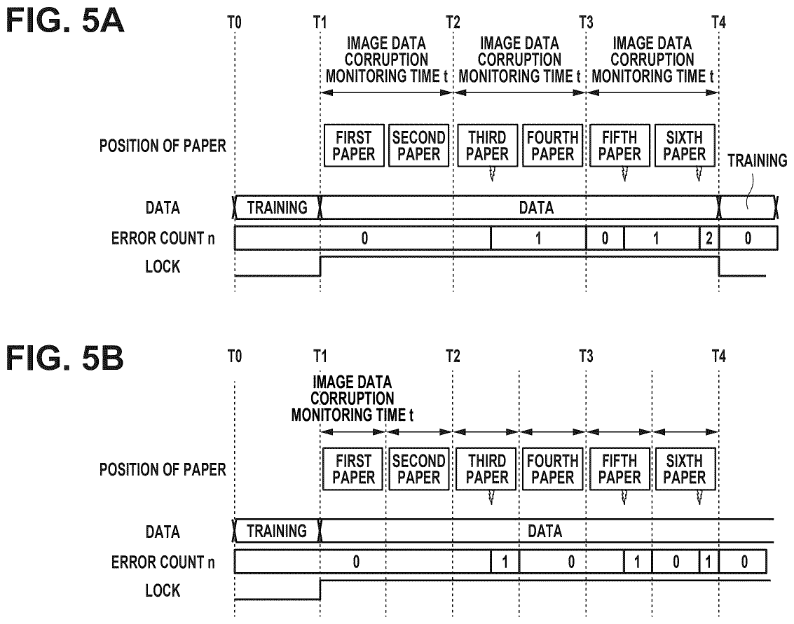

A general concept of the operation of the high-speed serial communication and the detection of an error in image data that is conducted by the error detection unit 728 will be described with reference to FIG. 5A. The error detection unit 728 unlocks the clock recovery unit 723 in a case where detecting image data corruption a predetermined number of times in a time length set in the register or the like. Whether the image data is corrupted is determined based on whether the received image data is data deviating from a determined communication protocol. The operation will be described assuming that t represents a monitoring time for image data corruption, which corresponds to a predetermined period, and the number of times of image data corruption to stop the communication is twice. Assume that the monitoring time for image data corruption and the number of times of image data corruption to stop the communication can be changed to any time length and any number of times by setting the register.

During T0 to T1, the image controller unit 700 transmits the initial communication training signal, and the printed circuit board 202 configures initial settings based on the received training signal. After the initial settings are completed, the lock signal 704 is set to ON and then the preparations for the communication are completed.

A period of T1 to T2 indicates an example in which no image data corruption occurs due to static electricity. After the clock recovery unit 723 is locked at T1, data is transmitted and received. An error count n remains zero because no image data corruption occurs due to static electricity.

A period of T2 to T3 indicates an example in which image data corruption occurs due to static electricity only once. The error count n is incremented to 1 when image data corruption occurs. The error monitoring time is ended at T3, and the error count n returns to zero.

A period of T3 to T4 indicates an example in which image data corruption occurs due to static electricity twice, which satisfies the unlocking condition. The error count n is incremented to 2 when image data corruption is detected twice. This serves as a trigger, and the serial-to-parallel conversion unit 724 unlocks the clock recovery unit 723, and the communication is stopped and the training is conducted again after T4.

### Regarding Static Electricity Due to Electrically Charged Paper and Setting of Image Data Corruption Monitoring Time

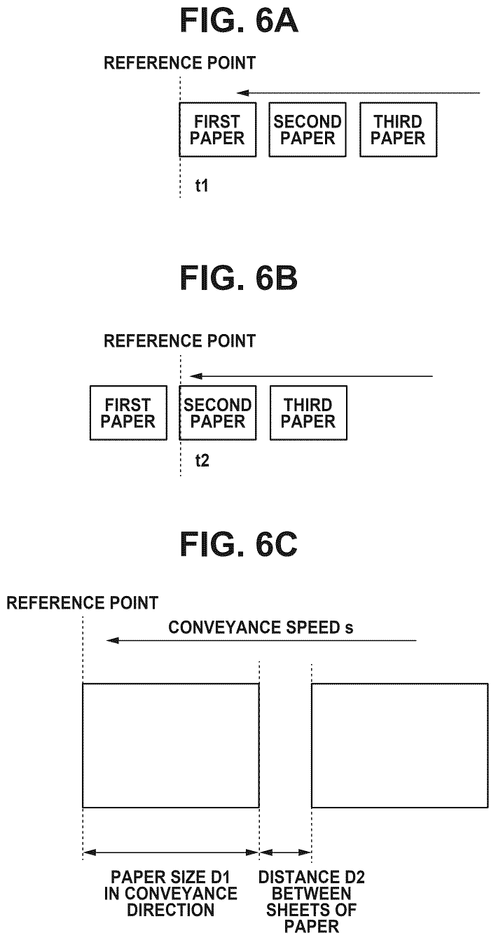

Paper used in printing is being electrically charged while being conveyed in the main body of the multifunction peripheral. To remove electric charges, an anti-static component such as a static electricity removal brush is disposed in the conveyance path. However, electric charges cannot be completely removed by the static electricity removal brush and are accumulated by a certain amount, and are discharged to a metallic portion when the paper passes through near a highly electrically conductive metallic component or the like. All the electric charges accumulated on the paper are discharged at this time, and therefore static electricity is rarely discharged a plurality of times per conveyance of a sheet of paper. In light thereof, supposing that static electricity is discharged not more than once per conveyance of a sheet of paper, the monitoring time for image data corruption is set according to the conveyance speed of the multifunction peripheral and the paper size to prevent the communication from being stopped due to image data corruption caused thereby, a method of which will be described now with reference to FIGS. 5B, 6A, 6B, and 6C.

FIGS. 6A, 6B, and 6C each illustrate a general concept of the conveyance of paper as viewed from some reference point. FIG. 6A illustrates a timing when the leading edge of the first paper reaches the reference point. Assume that t1 represents a time at this timing. FIG. 6B illustrates a timing when the leading edge of the second paper reaches the reference point. Assume that t2 represents a time at this timing.

Setting the image data corruption monitoring time to t3 based on a time difference between these t1 and t2 can prevent a plurality of sheets of paper from passing through in the image data corruption monitoring time, i.e., prevent an influence of static electricity due to electrically charged paper from occurring twice or more. The time t3 can be calculated from the conveyance speed of the paper and the paper size. FIG. 6C illustrates an example of the calculation of t3. Assuming that S represents the conveyance speed of the paper, D1 represents the paper size in the conveyance direction, and D2 represents a distance between the sheets of paper from the trailing edge of the first paper to the leading edge of the second paper, t3 can be expressed by an equation (1).

$$t 3 = ( D 1 + D 2 ) / S \qquad ( 1 )$$

This is an example of the calculation method, and a change in the conveyance speed or the like is expected in reality. For this reason, the image data corruption monitoring time is set to an appropriate time that can prevent a plurality of sheets of paper from passing through during the image data corruption monitoring time according to the apparatus configuration.

The conveyance speed of the multifunction peripheral varies depending on the machine model and the paper type (plain paper, thick paper, or the like), and the time corresponding to D1 varies depending on the paper size in use. For this reason, a table of the image data corruption monitoring time according to each case is stored in a storage medium such as a not-illustrated memory in advance.

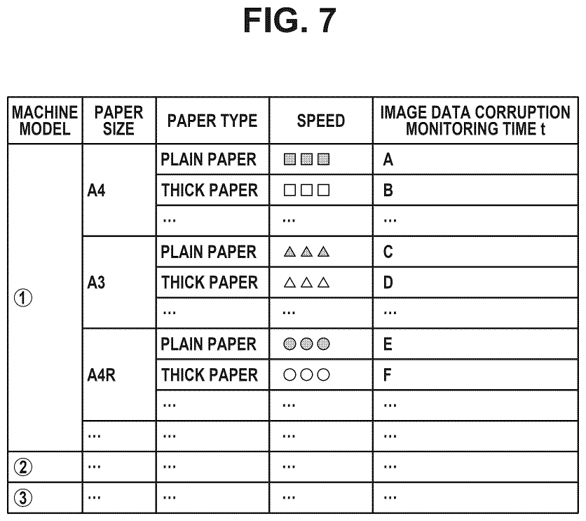

FIG. 7 illustrates an example of the data stored in the storage medium. As described above, the calculated image data corruption monitoring time t3 is stored in advance for each machine model different in conveyance speed and for each condition such as a combination of a paper size and a paper type. The image controller unit 700 refers to the machine model information and the content of the job set by a user and sets the monitoring time that matches the condition before image data communication is started.

FIG. 5B illustrates a general concept of the operation of the high-speed serial communication and the detection of image data corruption in image data that is conducted by the serial-to-parallel conversion unit 724 when the image data corruption monitoring time is set to t3. The operation will be described assuming that the number of times of image data corruption to stop the communication is twice, similarly to the description of FIG. 5A.

In FIG. 5A, because two sheets of paper are conveyed during the period of T3 to T4 and static electricity is discharged from each of the sheets, the communication is stopped. In FIG. 5B, setting the image data corruption monitoring time to t3 causes only one sheet of paper to be conveyed during the monitoring time, thereby allowing image data corruption due to static electricity to be counted not more than once, leading to no execution of the communication stop processing.

The image data corruption monitoring time set to a too short time makes it impossible to stop the communication and/or conduct the training even when image data corruption occurs in such a manner that the print output undesirably contains a visibly noticeable image failure therein. Setting the monitoring time in the above-described manner can achieve such an optimum setting that the monitoring time is not too short and the communication is prevented from being stopped due to static electricity derived from the paper.

### Flowchart

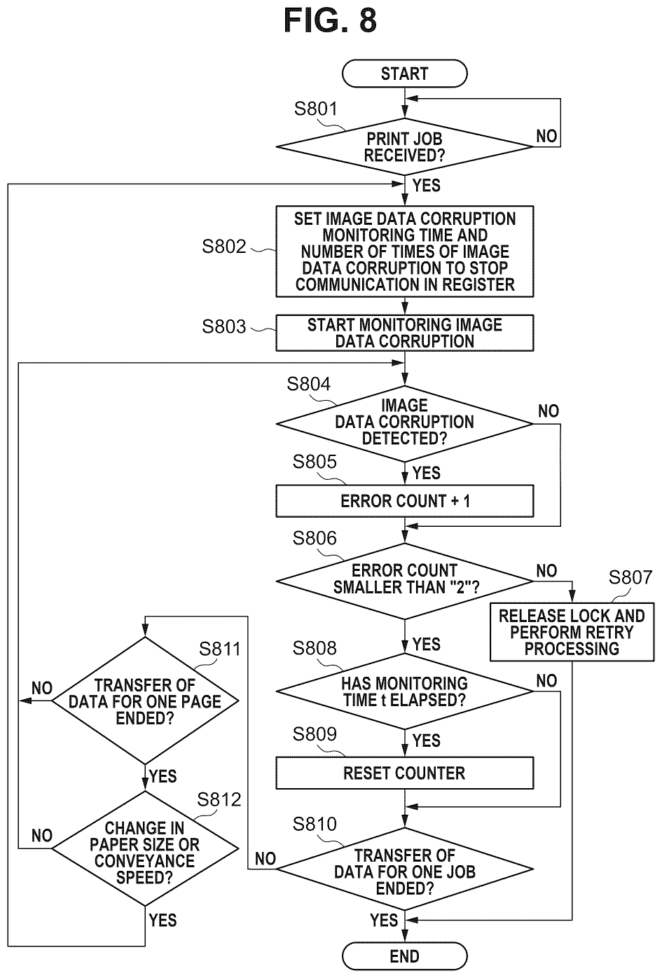

A flowchart of the detection of image data corruption in the high-speed serial communication according to the present embodiment will be described with reference to FIG. 8. The flowchart illustrated in FIG. 8 starts from when the image forming apparatus is powered on, the initial communication training of the serial communication unit is completed, and the lock signal 704 output from the clock recovery unit 723 indicates a locked state.

In step S801, the image forming apparatus waits for receiving a print job. In a case where the image forming apparatus receives a print job (YES in step S801), the processing proceeds to step S802.

In step S802, the CPU 703 selects an appropriate value from the setting data stored in the storage medium in advance according to the machine model and the information about the job, and sets the monitoring time for image data corruption in the register of the serial-to-parallel conversion unit 724. The register may be set from the differential signal 712 or may be set via not-illustrated another communication route.

In step S803, the error detection unit 728 starts monitoring image data corruption.

In step S804, the error detection unit 728 detects whether the received image data contains image data corruption. In a case where image data corruption is detected (YES in step S804), the processing proceeds to step S805. In a case where no image data corruption is detected and the image data is normally received (NO in step S804), the processing proceeds to step S806.

In step S805, the error detection unit 728 increments the register value storing the value of the error count by one.

In step S806, the error detection unit 728 confirms the value of the error count, which corresponds to a predetermined value. In a case where the count value is smaller than 2 (YES in step S806), the processing proceeds to step S808. In a case where the count value reaches 2 (NO in step S806), the processing proceeds to step S807.

In step S807, the clock recovery unit 723 releases the lock signal. Upon detecting that the lock signal is released, the CPU 703 performs error processing according to the needs, such as stopping the main body, retrying the print processing, and restarting the communication after re-training.

In step S808, the error detection unit 728 determines whether the time elapsed since the start of monitoring image data corruption in step S803 has exceeded the monitoring time set in the register. In a case where the elapsed time has reached the set time (YES in step S808), the processing proceeds to step S809. In a case where the elapsed time has not reached the set time (NO in step S808), the processing proceeds to step S810.

In step S809, the error detection unit 728 resets the value of the error count set in the register to zero.

In step S810, the parallel-to-serial conversion unit 710 determines whether the data transfer for one job is ended. In a case where the communication for one job is ended (YES in step S810), the processing is ended. In a case where the communication for one job is not ended (NO in step S810), the processing proceeds to step S811.

In step S811, the parallel-to-serial conversion unit 710 determines whether the data transfer for one page is ended. In a case where the data transfer for one page is not ended (NO in step S811), the processing proceeds to step S804, in which the error detection unit 728 continues monitoring image corruption. In a case where the data transfer for one page is ended (YES in step S811), the processing proceeds to step S812.

In step S812, the parallel-to-serial conversion unit 710 determines whether there is a change in the print conditions such as the paper size and the conveyance speed. In the case of, for example, a job in which different paper sizes are mixed, the print conditions vary page by page, which makes it necessary to confirm whether there is a change page by page. In a case where there is no change (NO in step S812), the processing proceeds to step S804, in which the error detection unit 728 continues monitoring image corruption. In a case where there is a change (YES in step S812), the processing proceeds to step S802, in which the CPU 703 changes the monitoring time for image data corruption according to the print conditions and the error detection unit 728 continues monitoring image corruption.

This processing allows the monitoring time for image data corruption to be changed according to the paper size and the conveyance speed, thereby allowing the data communication to continue without treating image data corruption due to static electricity generated by paper as an error.

According to the present disclosure, it is possible to reduce a possibility that data cannot be correctly transmitted in an image forming apparatus configured to communicate a data signal by a serial communication method.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-155511, filed Sep. 10, 2024, which is hereby incorporated by reference herein in its entirety.

What is claimed is:

1. An image forming apparatus configured to form an image on a recording medium, the image forming apparatus comprising:
a rotational photosensitive member;
an exposure device including a plurality of light emitting elements and a driving unit, the plurality of light emitting elements being arranged along a rotational axis direction of the photosensitive member and configured to emit light to expose the photosensitive member, the driving unit being configured to drive the plurality of light emitting elements;
an output unit configured to superimpose a clock signal for driving the exposure device on image data for controlling lighting-up of the plurality of light emitting elements, and output the image data as serial data;
a generation unit configured to recover and generate the clock signal superimposed on the image data;
a conversion unit configured to receive the serial data output from the output unit and convert the received serial data into parallel data;
a lock signal output unit configured to lock the generation unit and output a lock signal in a case where the generation unit generates the clock signal at a predetermined frequency; and
a control unit configured to count a number of times that the conversion unit has not received the serial data normally during a predetermined period, and unlock the generation unit in a case where the number of times that the conversion unit has not received the serial data normally exceeds a predetermined value.

2. The image forming apparatus according to claim 1, wherein the predetermined period is determined based on a conveyance speed at which the image forming apparatus conveys the recording medium.

3. The image forming apparatus according to claim 2 wherein the predetermined period is changed to a new value based on a change made to the conveyance speed.

4. The image forming apparatus according to claim 2, further comprising a memory configured to store a time corresponding to the predetermined period,
wherein the memory stores the predetermined period according to each of a plurality of conveyance speeds.

5. The image forming apparatus according to claim 1, wherein the predetermined value is twice.

6. The image forming apparatus according to claim 1, wherein the plurality of light emitting elements is organic electro-luminescence (EL).
